(19) United States
(12) Patent Application Publication
(10) Pub. No.: US 2013/0222293 A1
(43) Pub. Date: Aug. 29, 2013

(54) ROTATION TYPE TOUCH SCREEN MODULE AND TERMINAL HAVING THE SAME

(71) Applicant: Pantech Co., Ltd., (US)

(72) Inventor: Kyung Il CHUNG, Seoul (KR)

(73) Assignee: Pantech Co., Ltd., Seoul (KR)

(21) Appl. No.: 13/724,851

(22) Filed: Dec. 21, 2012

(30) Foreign Application Priority Data
Feb. 29, 2012 (KR) 10-2012-0020969

(51) Int. Cl. G06F 3/041

(52) U.S. Cl. CPC G06F 3/041
USPC 345/173

(57) ABSTRACT

Provided is a terminal including a main body module including a control unit; and a rotation-type touch screen module disposed at one side of the main body module, and including a module housing extending from the main body module, and a loop touch screen rotatable about at least a portion of the module housing in at least one direction, and provided with at least one contact member electrically connected to the control unit.

### CROSS-REFERENCE TO RELATED APPLICATION

This application claims priority from and the benefit under 35 U.S.C. §119, of Korean Patent Application No. 10-2012-0020969, filed on Feb. 29, 2012, which is hereby incorporated by reference for all purposes as if fully set forth herein.

### BACKGROUND

1. Field

Exemplary embodiments of the present invention relate to a rotation-type touch screen module and a terminal including the same.

2. Discussion of the Background

Generally, terminals enable signal exchange between a user and another party. Terminals may include various mobile communication terminals, such as a cell phone, a personal communication service (PCS), a personal digital assistance (PDA), a tablet computer, and the like, which enable the user to communicate with the other party while moving. For user convenience and portability, the terminals are being provided to users in a bar type, a flip type, a folder type, a slider type, and the like.

Generally, a terminal includes a display unit and a control unit. A driver integrated circuit (IC) may be mounted to one side of the display unit while a connector, for example a board-to-board (B-to-B) connector, is mounted to the control unit. The display unit and the control unit may be connected by a flexible printed circuit board (FPCB).

According to the foregoing structure, the display unit and the control unit are fixed at one side by the connector connected to the FPCB. Accordingly, movements of the display unit and the control unit are limited to a degree in one direction or opposite directions.

Therefore, although the foregoing structure may be applicable to a slider-type terminal, a swing phone, a swivel phone, and the like, according to a movable distance of the FPCB, the movement is limited.

A related-art terminal employing a touch screen is usually configured to move or manipulate an interface in a software manner, i.e., software is operated to provide a touch screen, which is manipulate through receiving touch inputs thereon. However, since movement and manipulation of the interface is performed by calculating an approximate value of a touch, operational accuracy is limited.

### SUMMARY

Provided is a rotation-type touch screen module and a terminal including the same, in which a loop touch screen connected to a main body module is rotatable in a hardware manner, i.e., physically, rather than a software manner so that a more interactive interface is provided

Additional features of the invention will be set forth in the description which follows, and in part will be apparent from the description, or may be learned by practice of the invention.

Exemplary embodiments of the present invention provide a touch screen module connectable to a terminal, the touch screen module including at least one roller disposed in the touch screen module; a support structure disposed adjacent to the at least one roller; and a touch screen disposed about the at least one roller and the support structure.

Exemplary embodiments of the present invention provide a terminal, including: a main body module including a control unit; and a rotation-type touch screen module disposed at one side of the main body module, the rotation-type touch screen module including: a module housing extending from the main body module, and a loop touch screen rotatable about at least a portion of the module housing in at least one direction, the loop touch screen including at least one contact member electrically connected to the control unit and disposed on an inner surface of the loop touch screen.

Exemplary embodiments of the present invention provide a terminal, including: at least one roller disposed in the terminal and including at least one recess; a support structure disposed adjacent to the at least one roller; and a touch screen disposed rotatably about the at least one roller and the support structure and including at least one protrusion in alignment with the at least one recess to synchronize rotation of the touch screen and the at least one roller.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view illustrating an external appearance of a terminal according to exemplary embodiments of the present invention.

FIG. 2 is a diagram illustrating a partial structure of a main body module and an inner structure of a rotation-type touch screen module according to exemplary embodiments of the present invention.

FIG. 3 is a diagram illustrating an electrical connection structure according to exemplary embodiments of the present invention.

FIG. 4 is a view illustrating engagement between a roller and a loop touch screen according to exemplary embodiments of the present invention.

FIG. 5 is a front view illustrating a structure for detecting a movement degree of a loop touch screen according to exemplary embodiments of the present invention.

FIG. 6 is a front view illustrating a structure for detecting a movement degree of the loop touch screen according to exemplary embodiments of the present invention.

FIG. 7 is partial enlarged view illustrating an electrical connection structure between a control unit and a loop touch screen according to exemplary embodiments of the present invention.

FIG. 8 is a diagram illustrating an inner structure of a connection member according to exemplary embodiments of the present invention.

FIG. 9 is a diagram illustrating arrangement and an electrical connection structure between a display and an input unit according to exemplary embodiments of the present invention.

FIG. 10 is a diagram illustrating an interlayer connection structure of a contact member according to exemplary embodiments of the present invention.

FIG. 11 is a diagram illustrating an application example of a terminal according to exemplary embodiments of the present invention.

FIG. 12 is a diagram illustrating another application example of a terminal according to exemplary embodiments of the present invention.

FIG. 13 is a diagram illustrating still another application example of a terminal according to exemplary embodiments of the present invention.

### DETAILED DESCRIPTION OF THE ILLUSTRATED EMBODIMENTS

Exemplary embodiments of the present invention are described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

It will be understood that when an element is referred to as being “connected to” another element, it can be directly connected to the other element, or intervening elements may be present. A following description presents various aspects of the present invention. However, in describing the exemplary embodiments, if detailed descriptions of related disclosed art or configurations are determined to unnecessarily make the subject matter of the present invention obscure, they will be omitted.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

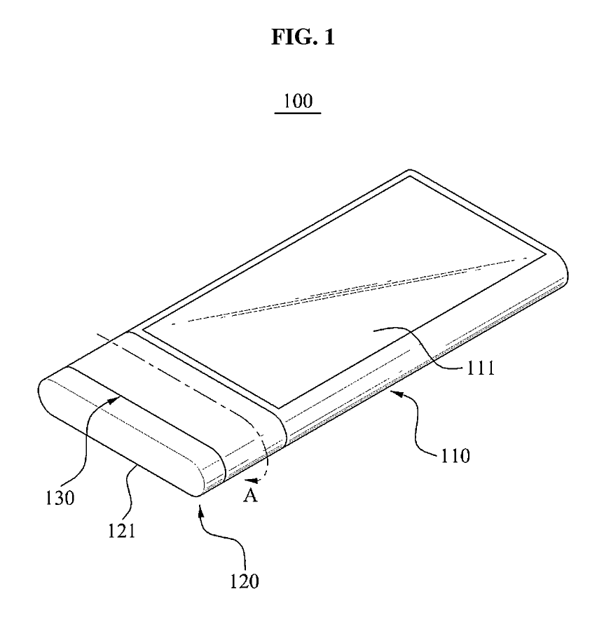

FIG. 1 is a perspective view illustrating an external appearance of a terminal according to exemplary embodiments of the present invention.

Referring to FIG. 1, a terminal 100 may include a main body module 110 in which a main display 111 is disposed or mounted, and a rotation-type touch screen module 120 connected to one side of the main body module 110. The terminal 100 may be a mobile communication terminal, such as a cell phone, a personal communication service (PCS), a personal digital assistance (PDA), a tablet computer, and the like; however, aspects need not be limited thereto. The rotation-type touch screen module 120 may be rotated within a range in a direction by application of an external physical force. As shown in FIG. 1, the rotation-type touch screen module 120 is rotatable in an arrowed direction A and the opposite direction.

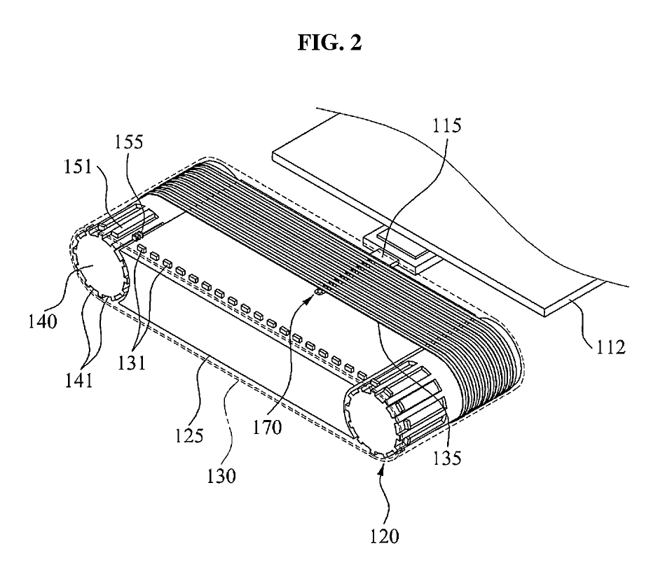

FIG. 2 is a diagram illustrating a partial structure of a main body module and an inner structure of a rotation-type touch screen module according to exemplary embodiments of the present invention. As shown in FIG. 2, the main body module 110 may further include a control unit 112 disposed inside the main body module 110 to control components, in addition to the main display 111, which forms a main screen. The control unit 112 may be a main printed circuit board (PCB).

The rotation-type touch screen module 120 may be physically rotated in the arrowed direction A by an external physical force, thereby controlling various functions according to the rotation. According to exemplary embodiments, the external physical force may be a user input or manipulation, such as a touch, a flick, and the like, input via a finger, a stylus, and the like.

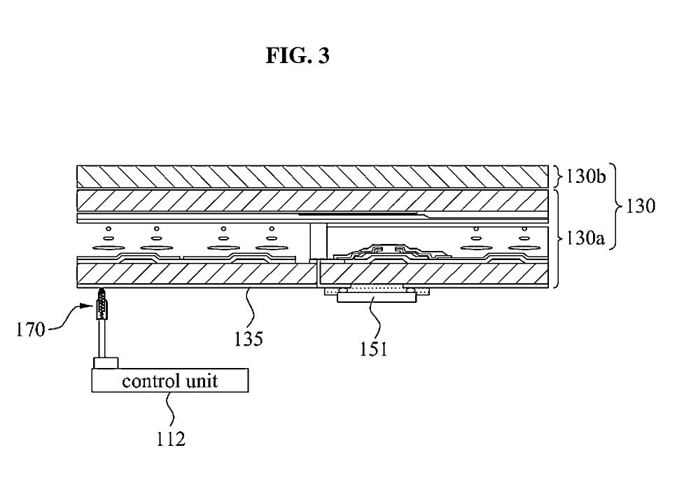

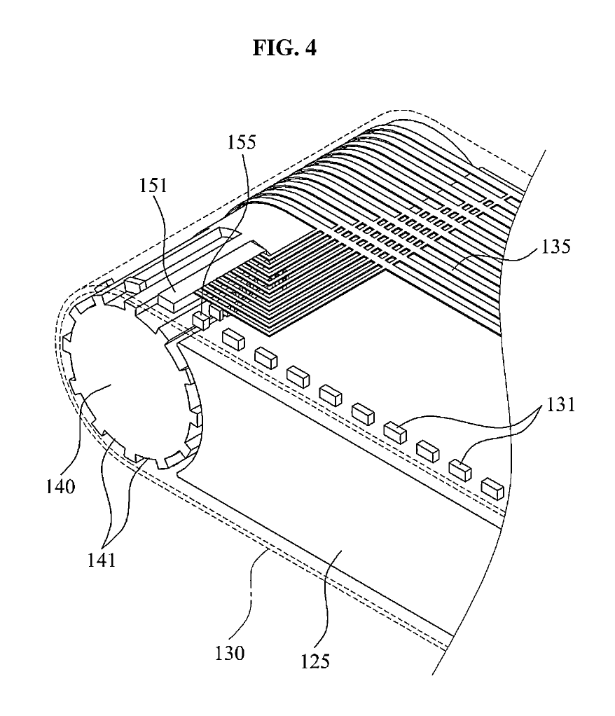

The rotation-type touch screen module 120 may include a module housing 121 forming an external appearance of the rotation-type touch screen module 120. Further the rotation-type touch screen module 120 may include a loop touch screen 130. The rotation-type touch screen module 120 may be disposed at a side of the main body module 110. As shown in FIG. 2, FIG. 3, and FIG. 4, the rotation-type touch screen module 120 may include at least one roller 140 disposed in the module housing 121, a support structure 125 disposed to reinforce and/or support an entire structure, and the loop touch screen 130. The loop touch screen 130 may be disposed about the at least one roller 140 and may be a closed loop rotatable by an external physical force and rotatable in association with the at least one roller 140.

FIG. 4 is a view illustrating engagement between a roller and a loop touch screen according to exemplary embodiments of the present invention. A contact member 135 including a circuit structure, for example, a flexible PCB (FPCB), may be disposed inside the loop touch screen 130 and may be supported by the support structure 125. The contact member 135 may contact a connection member 170 to transmit information about the rotation of the loop touch screen 130 to the control unit 112 of the terminal 100.

For stable rotation of the rotation-type touch screen module 120, a pair of rollers 140 may be provided as the at least one roller 140, and the pair of rollers 140 may be symmetrically disposed in an inner space of the module housing 121. The support structure 125 may be disposed between the pair of rollers 140 to support the loop touch screen 130 of the rotation-type touch screen module 120.

The module housing 121 may be shaped corresponding to an external appearance of the main body module 110 so as to have a similar external shape as the main body module 110, and the module housing 121 may be integrally formed to extend from an external portion of the main body module 110. However, aspects need not be limited thereto such that the module housing 121 may be separate from and connectable to the main body module 110. The loop touch screen 130 may be exposed on at least a partial area of the rotation-type touch screen module 120, i.e., the loop touch screen 130 may be disposed in the rotation-type touch screen module 120 such that at least a partial area of one surface of the rotation-type touch screen module 120 exposes a portion of the loop touch screen 130 or the loop touch screen 130 may be disposed to completely exposed about the entire rotation-type touch screen module 120 so as to circumnavigate a surface of the terminal 100. Further, the loop touch screen 130 may be exposed on a surface extended from or shared with the main display 111 of the main body module 110.

FIG. 3 is a diagram illustrating an electrical connection structure according to exemplary embodiments of the present invention. To describe a structure of the loop touch screen 130 with reference to FIG. 3, the loop touch screen 130 includes the display 130a configured to display a moving or still image and the input unit 130b configured to detect a touch operation. The display 130a may be a sub display disposed under the input unit 130b. The display 130a may be a display including thin film transistors, light emitting diodes, circuitry, etc. The display 130a and the input unit 130b may be rotated by the same degree in the same direction according to a user operation. The display 130a and the input unit 130b may be made of a flexible material and formed in a loop shape to be rotatable about the rotation-type touch screen module 120. A touch panel may be applied as the input unit 130b.

The respective elements will be described. First, the module housing 121 forming a base frame of the rotation-type touch screen module 120 may support various structures inside or outside. The support structure 125 is provided in the module housing 121, thereby reinforcing or supporting the entire structure of the rotation-type touch screen module 120.

The support structure 125 may be disposed to partially surround each of the at least one roller 140, by including a curve surface formed at a side facing the at least one roller 140 corresponding to or following the shape of the at least one roller 140. Therefore, when the at least one roller 140 rotates according to rotation of the loop touch screen 130, the at least one roller 140 may rotate stably and be maintained in appropriate or intended positions.

The loop touch screen 130 and the at least one roller 140 may be meshed with or connected to each other so that a rotational slip of the loop touch screen 130 may be prevented and an accurate rotation degree of the loop touch screen 130 may be measured. That is, each of the at least one roller 140 may include a first toothed or geared structure, for example a recess, disposed in at least a partial area of an outer circumference contacting the loop touch screen 130 to be orthogonal to the rotational direction along the rotational direction of the loop touch screen 130. The first toothed or geared structure may be understood as protrusions extending from, recesses extending into, or alternating protrusions and recesses disposed on the surface of the at least one roller 140. In addition, another or second toothed structure, for example a protrusion, may be formed in at least a partial area of an inner surface of the loop touch screen 130, which contacts the at least one roller 140, to be meshed with or connected to the first geared structure of the at least one roller 140. Also, the second geared structure is formed orthogonal to the rotational direction and along the rotational direction of the loop touch screen 130. Moreover, the loop touch screen 130 may include only one protrusion or recess while the at least one roller 140 includes the other of the only one protrusion or recess, and, although shown as extending parallel to an axis of rotation of the at least one roller 140, aspects need not be limited thereto such that the protrusion(s) and recess(es) may extend to cross the axis of rotation of the at least one roller 140. For example, one recess may extend about the at least one roller 140 and one protrusion may extend along a surface of the loop touch screen 130 to engage the one recess of the at least one roller 140 and synchronize the rotation of the loop touch screen 130 and the at least one roller 140.

Referring to FIG. 4, a plurality of protrusions 131 are protruded uniformly on or extended from the inner surface of the loop touch screen 130. Correspondingly, each of the at least one roller 140 may include a plurality of recesses 141. Each of the protrusions 131 and/or the recesses 141 may extend across the entire surface on which the protrusions 131 and/or the recesses 141 are respectively disposed or may extend only partially. Further, protrusions 131 may be disposed on and extend from a surface of the loop touch screen 130 disposed adjacent to the at least one roller 140, and the at least one roller 140 may include recesses 141 disposed on and extending into a surface of the at least one roller 140 disposed adjacent to the loop touch screen 130 such that the protrusions 131 and recesses 141 align to synchronize rotation of the loop touch screen 130 and the at least one roller 141.

Therefore, when the loop touch screen 130 is rotated in one direction, the at least one roller 140 may be rotated along with rotation of the loop touch screen 130. Also, a slip of the loop touch screen 130 may be prevented by the first and second geared structures of the loop touch screen 130 and the at least one roller 140.

In addition, owing to the teeth structures, the rotation degree of the loop touch screen 130 may be accurately detected, accordingly enabling an accurate operation. Furthermore, size, for example width, of the protrusions 131 and the recesses 141 may be set according to a desired accuracy of a rotation degree. That is, when the width of the protrusions 131 and the teeth recesses 141 are relatively large, an approximate rotation degree of the loop touch screen 130 may be detected. When the width of the protrusions 131 and the teeth recesses 141 are relatively small, the rotation degree may be more accurately detected.

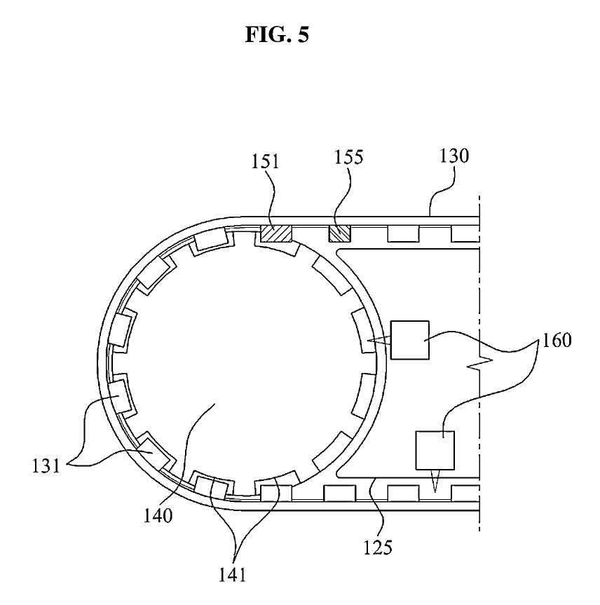

FIG. 5 is a front view illustrating a structure for detecting a movement degree of a loop touch screen according to exemplary embodiments of the present invention. Referring to FIG. 5, the support structure 125 disposed inside the module housing 121 may include a detection unit 160 configured to detect a movement of the plurality of recesses 141 formed at or disposed on the at least one roller 140 and the plurality of protrusions 131 formed at or disposed on the loop touch screen 130. The detection unit 160 may be a lever detector switch, which counts a number of movements of the plurality of recesses 141 or protrusions 131 according to clicks. As a result, the movement degree of the loop touch screen 130 may be detected.

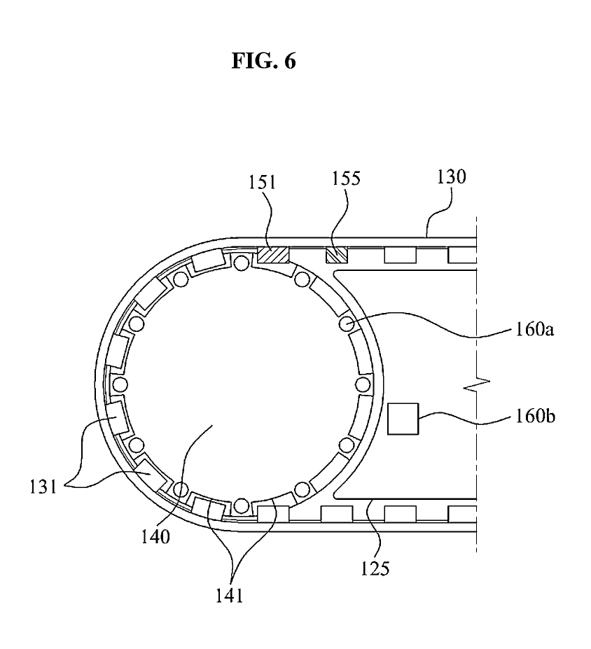

FIG. 6 is a front view illustrating a structure for detecting a movement degree of the loop touch screen according to exemplary embodiments of the present invention. A magnetic structure may be applied as shown in FIG. 6. Magnet members 160a may be arranged between the respective recesses 141 of the at least one roller 140 and magnet detectors 160b for detecting the magnet members 160a may be disposed in the support structure 125. For example, the magnet members 160a may be disposed in the protrusions adjacent to the recesses 141 in the at least one roller 140. Although magnet members are shown in each of the protrusions adjacent to the recesses 141 in the at least one roller 140, aspects need not be limited thereto such that there may be only one magnet member 160a disposed in the at least one roller 140, or there may be magnet members 160a in some but not each of the protrusions adjacent to the recesses 141 in the at least one roller 140. Therefore, using magnetism, the number of movements of the recesses 141 or the protrusions 131 may be counted in a clicking manner. Accordingly, the movement degree of the loop touch screen 130 may be detected.

Although not shown, the detection unit 160 may be mounted to an axis of the at least one roller 140. In this case, the movement degree of the loop touch screen 130 may be detected through detection of the rotation angle of the at least one roller 140.

The movement degree of the loop touch screen 130 detected by a detection unit may be transmitted to a controller, for example, the control unit 112 of the main body module 110, and processed by the user input.

In the terminal 100, the electrical connection may be maintained even during rotation of the loop touch screen 130. Also, interference between the loop touch screen 130 and electric parts of the terminal 100 may be prevented and/or decreased.

Referring to FIG. 2, on the inner surface of the loop touch screen 130, a plurality of the contact members 135, that is, the FPCB, may be arranged in parallel along the rotational direction of the loop touch screen 130. The contact members 135 may be electrically connected to a driver integrated circuit (IC) 151 or electric parts 155 as shown in FIG. 3.

The driver IC 151 and the electric parts 155 may be connected to the inner surface of the loop touch screen 130 and moved along with the rotation of the loop touch screen 130. To prevent and/or decrease interference of the driver IC 151 and the electric parts 155 with the recesses 141 of the at least one roller 140, the driver IC 151 and the electric parts 155 may be mounted to the inner surface of the loop touch screen 130 corresponding to the arrangement of the recesses 141, as shown in FIG. 5. As shown in FIG. 5, the driver IC 151 and the electric parts 155 may be disposed similar to as protrusions 131 on the inner surface of the loop touch screen 130 so as to engage with the recesses 141 of the loop touch screen 130.

Mobile interface systems are generally applying a micro display digital interface (MDDI) that is a high speed serial interface, and a mobile industry processor interface (MIPI), which are effective to reduce a data line. The MDDI and the MIPI are applicable to the control unit 112 and the driver IC 151. Here, because the driver IC 151 may be mounted to the loop touch screen 130, the data line may be reduced, thereby achieving a simplified structure.

The loop touch screen 130 may be smoothly moved using the pair of rollers 140 as both axes, while the driver IC 151, the electric parts 155, and the contact members 135 each including the circuit structure connected with the driver IC 151 and the electric parts 155 are in a fixed to move with the rotation of the loop touch screen 130.

Here, reliable electrical connection among the electric parts of the loop touch screen 130 and the control 112 of the main body module 110 is described. As shown in FIG. 2, the rotation-type touch screen module 120 may further include connection members 170 disposed inside the module housing 121 to be electrically connected with a connector 115 of the main body module 110 and also electrically connected with the contact members 135.

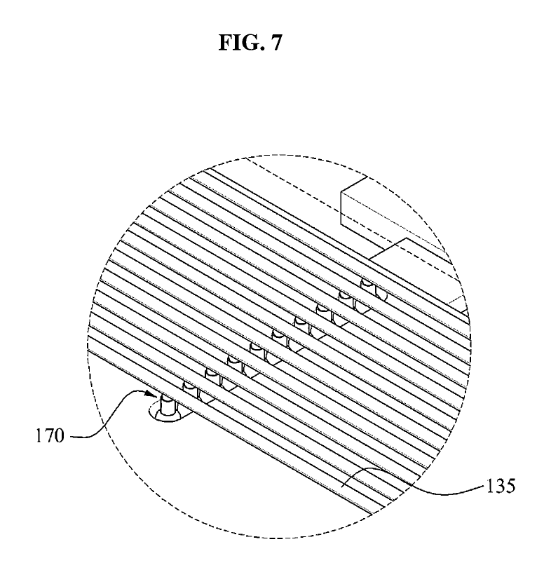

FIG. 7 is partial enlarged view illustrating an electrical connection structure between a control unit and a loop touch screen according to exemplary embodiments of the present invention. Referring to FIG. 7, the connection members 170 may be fixed to the support structure 125 in the module housing 121 to constantly maintain contact with the contact members 135, which are rotatable with the rotation of the loop touch screen 130.

The contact members 135 may be arranged along the inner surface of the loop touch screen 130, and the contact members 135 may be disposed in parallel closed loops. Also, the connection members 170 may be arranged corresponding to the contact members 135, i.e., the connection members 170 may be disposed in the support 125 so as to align and contact the contact members 135. Therefore, even when the contact members 135 are rotated by rotation of the loop touch screen 130, the connection members 170 may constantly maintain contact with the contact members 135 having the same loop curve as each other and as the loop touch screen 130.

However, aspects of the configuration of the contact members are not limited to the closed loop. For example, the contact members may be configured as open loops within a rotatable range of the loop touch screen 130. The loop touch screen 130 may be rotatable throughout 360°. However, if the loop touch screen 130 is rotatable not throughout an angle of 360° but by a range in opposite directions, such as 90°, the contact members 135 need not be closed loops. The contact members 135 may only be lines and the contact members 135 and the connection members 170 may be electrically connected only within the rotatable range along the length of the line contact members 135. Accordingly, the contact members 135 may be shaped corresponding to the rotatable range of the loop touch screen 130.

As a result, even during rotation of the loop touch screen 130, the electrical connection between the control unit 112 and the electric parts of the loop touch screen 130 may be maintained. The connection members 170 may have a predetermined degree of elasticity to maintain stable contact with the contact members 135 during rotation of the loop touch screen 130. That is, the connection members 170 may apply an elastic pressure to the contact members 135 when in contact with the contact members 135. In addition, the connection members 170 may include a curved surface in an area to contact the contact members 135, so that abrasion of the contact member 135 by repeated rotation of the loop touch screen 130 is prevented and/or decreased.

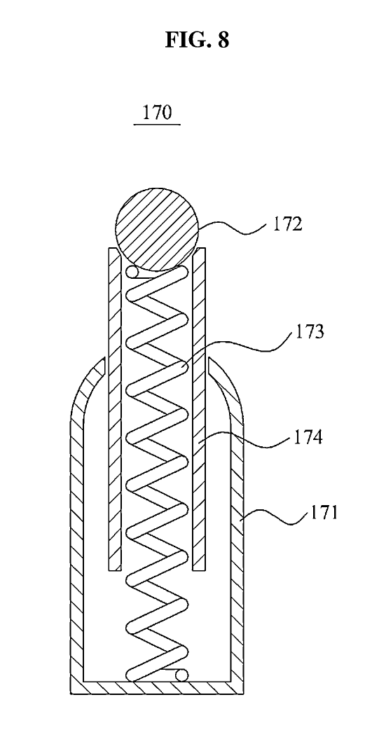

FIG. 8 is a diagram illustrating an inner structure of a connection member according to exemplary embodiments of the present invention. Each of the connection members 170 may be in a pogo pin type as shown in FIG. 8, including a fixed portion 171 fixed to the support structure 125, a contact portion 172 shaped as a ball for directly contacting the contact member 135, an elastic portion 173 connected to the fixed portion 171 with one end and to the contact portion 172 with an opposite end so as to elastically push the contact portion 172 toward the contact member 135, and a cover portion 174 configured to surround the contact portion 172 and the elastic portion 173 such that an upper end of the contact portion 172 is exposed to an outside. The elastic portion 173 may be a biasing member to bias the contact portion 172 in a direction toward the contact member 135 of the loop touch screen 130.

The contact portion 172 of the connection member 170 and the contact member 135 may maintain stable contact with each other due to elasticity of the elastic portion 173, even when momentarily deformed by an external impact.

Although the connection members 170 are explained to be the pogo pin type, aspects need not be limited thereto such that other structures, for example a C-clip structure, may be applied to the connection members 170.

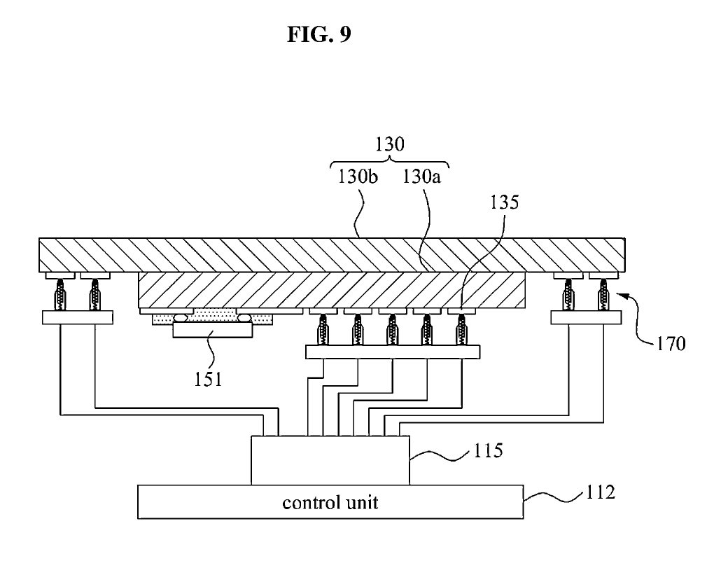

FIG. 9 is a diagram illustrating arrangement and an electrical connection structure between a display and an input unit according to exemplary embodiments of the present invention. Referring to FIG. 9, the contact members 135 are disposed on a rear surface of the input unit 130b of the loop touch screen 130 and also on a bottom surface of the display 130a connected with the rear surface of the input unit 130b, and may be in the form of parallel rails. Accordingly, the electrical connection between the contact members 135 and the connection members 170 may be maintained although the loop touch screen 130 rotates. Furthermore, interference of the loop touch screen 130 with the driver IC 151 and the electric parts 155 may be prevented.

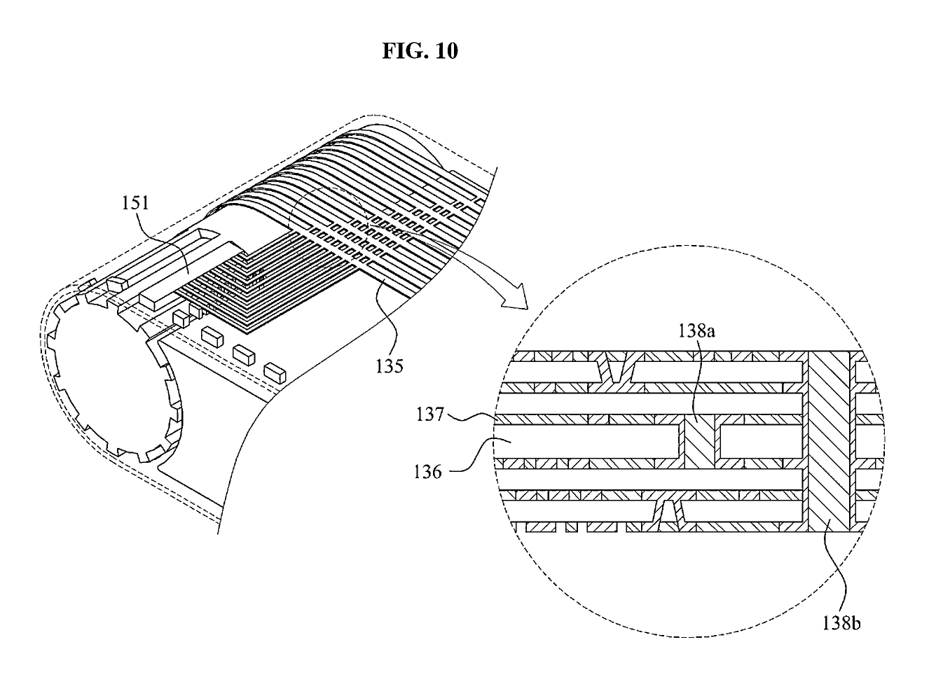

FIG. 10 is a diagram illustrating an interlayer connection structure of a contact member according to exemplary embodiments of the present invention. As shown in FIG. 10, the contact members 135, that is, the FPCB, may have a multilayer structure to avoid interference among one another and to connect the contact members 135 to the driver IC 151. That is, as shown in the enlarged view of FIG. 10, the electrical connection among the contact members 135 may be achieved without interference among the contact members 135, by conductive layers 137 and insulating layers 136 alternately layered and via holes 138a and 138b disposed between the conductive layers 137 and the insulating layers 136 to connect the conductive layers 137 to the driver IC 151.

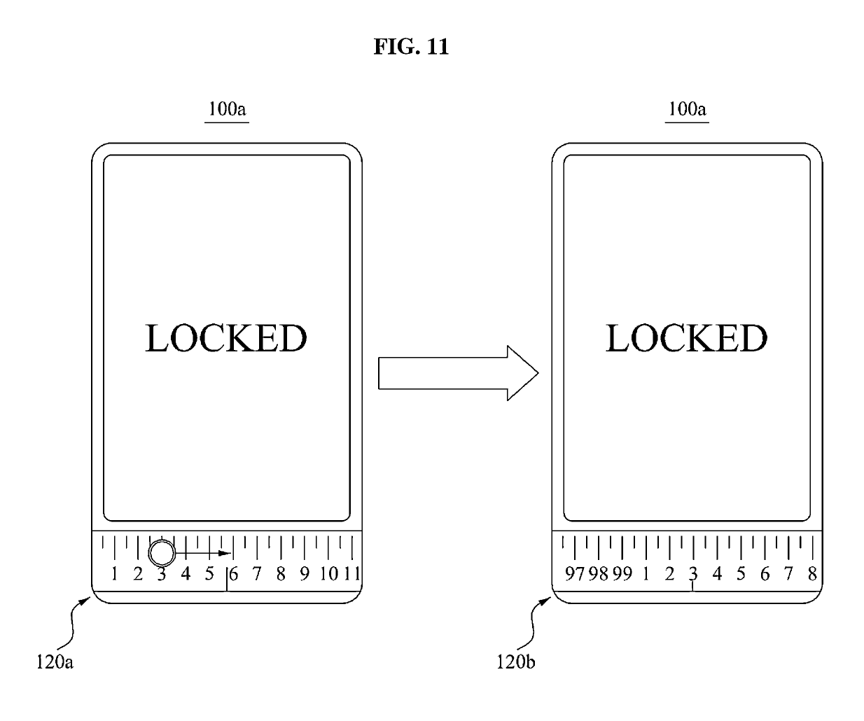

FIG. 11 is a diagram illustrating an application example of a terminal according to exemplary embodiments of the present invention.

Referring to FIG. 11, a display of a rotation-type touch screen module 120a of the terminal 100a may be marked with scales. In this case, a dial effect may be achieved by rotating a loop screen module.

In this example, a screen displayed during rotation of a loop touch screen may be organically changed as the scales are synchronized with clicks of rotation of the loop screen module. Therefore, for example, interactive unlocking of the terminal 100a may be performed.

For example, when the rotation-type touch screen module 120a is operated or rotated such that a dial number 3 displayed on the rotation-type touch screen module 120b is positioned in a middle as shown in FIG. 11, the terminal 100a may be unlocked. Further, the rotation-type touch screen module 120a may be rotated in both directions similar to a combination lock having a combination ending on 3 as shown in the rotation-type touch screen module 120b to unlock the terminal 100a, but aspects are not limited thereto.

Similarly, for example, volume of the terminal 100a may be interactively controlled by rotating the rotation-type touch screen module 120a in one direction to increase the volume and the other direction to decrease the volume of the terminal 100a. Also, media, such as video and music, may be controlled easily and quickly. For example, whereas related-art terminals require searching for a portion of the video or music, the terminal according to aspects of the present invention enables quick search based on a minimum video processing unit according to rotation of the rotation-type touch screen module 120a. For example, the video or music may be fastforwarded and reversed in association with respective directions of the rotation of the rotation-type touch screen module 120a. As aforementioned, the size, i.e., the width of recesses 141 of the at least one roller and/or the protrusions 131 of the loop touch screen may be set according to desired accuracy of the rotation degree. For example, when the width of the protrusions 131 is set to be relatively large, an approximate rotation degree of the loop touch screen may be detected. When the width of the protrusions 131 is set to be relatively small, the rotation degree may be more accurately detected. Using such a principle, the volume of the terminal, video, and media may be controlled easily and quickly.

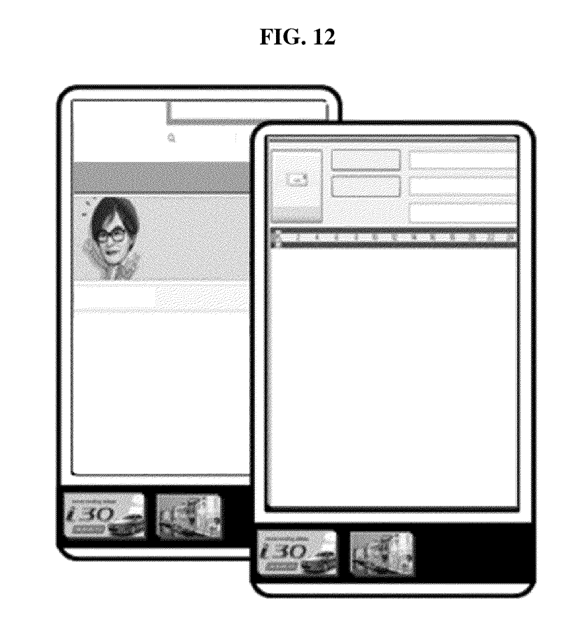

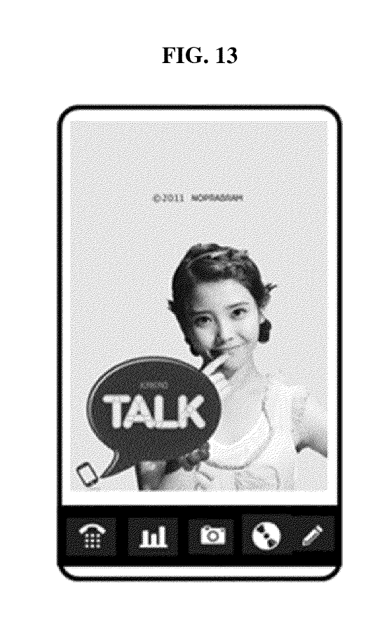

FIG. 12 is a diagram illustrating another application example of a terminal according to exemplary embodiments of the present invention. FIG. 13 is a diagram illustrating still another application example of a terminal according to exemplary embodiments of the present invention. Referring to FIGS. 12 and 13, a plurality of applications and/or actions may be simultaneously performed according to operation of a rotation-type touch screen module. That is, according to the operation of the rotation-type touch screen module, two screens may be alternately viewed and arranged in parallel. Also, a frequently used application or action may be designated for easy processing.

For example, searching for attached data during a document application or posting, display of an application and/or action in multitasking, display of tab contents of a web browser, execution of frequently used applications and/or actions by designating hot keys, and the like may be performed through a sub screen by an interactive operation with the rotation-type touch screen module.

In addition, the rotation-type touch screen module may be as a signaling lamp as well as an aesthetic design factor. For example, the rotation-type touch screen module may signal by a lamp, display letters, and display remaining battery power. Since the rotation-type touch screen module has a rotatable structure, the foregoing information may be viewed from a rear side.

Also, the rotation-type touch screen module may display information including letters, social networking service (SNS) text, a phone caller, and the like. The foregoing information may be viewed and controlled even from the rear side of the rotation-type touch screen module. In addition, due to the rotatable structure, the rotation-type touch screen module may function as an electric billboard.

Furthermore, the rotation-type touch screen module may enable stepwise input of a password using clicks.

The touch input of the main body module and the rotational input of the rotation-type touch screen module may be simultaneously performed, accordingly improving usability. That is, in a user experience (UX) environment including 2 layers, the touch input may control operation of a lower layer while the rotational input may control operation of an upper layer. Using such a system, a multilayer UX may be provided different from a one-screen and one-layer structure according to the related art.

Thus, since a loop touch screen of the rotation-type touch screen module connected to a main body module is rotatable in a hardware manner rather than a software manner, i.e., the loop touch screen is physically rotatable, a more interactive interface may be provided while operational accuracy is increased.

In addition, the loop touch screen may rotate without interfering with other components and maintain a reliable electrical connection with the control unit.

Although described as the rotation-type touch screen module being connected to the main body module structurally and electrically, the rotation-type touch screen module may be separately formed and connectable to the main body module. That is, the rotation-type touch screen module may include a module housing, a pair of rollers disposed on both sides in the module housing, the loop touch screen connected to the pair of rollers, and an interlink unit provided to at least one of the pair of rollers and the loop touch screen in order to link rotation of the loop touch screen with rotation of the pair of rollers.

As aforementioned, the interlink unit may include protrusions disposed at the loop touch screen and recesses disposed at the pair of rollers.

When separately provided, the rotation-type touch screen module may be formed as a closed loop so that the loop touch screen is fully rotatable, and may be partially opened and partially closed. That is, the loop touch screen rotatable within a predetermined range may be provided at one side of the rotation-type touch screen module while the module housing fixed to the opposite side is provided at the opposite side as a frame in which the loop touch screen may operate.

The rotation-type touch screen module may be a mere display not having a touch function or a mere operation unit not having a display function.

The loop touch screen may be provided at only a part of the rotation-type touch screen module while the module housing is equipped with a physical button. In this case, the physical button may be used as a power button, and a side button of the terminal be omitted.

Although the foregoing embodiments have been described such that the loop touch screen has a closed loop structure fully rotatable, exemplary embodiments of the present invention are not limited thereto. That is, only a part of the rotation-type touch screen module may be formed as the loop touch screen while the other part is formed as the module housing. The loop touch screen may be connected to the module housing. For example, assuming that a side of the rotation-type touch screen module including the main display is a front side, the loop touch screen may be disposed at the front side and the module housing may be disposed at a rear side.

In this case, a contact member may be provided only at a part of the loop touch screen corresponding to a shape of the loop touch screen. Therefore, the electrical connection may be achieved only when the loop touch screen is exposed, for example, when the loop touch screen is disposed on a front side of the terminal. Here, when a leading end of a connection member is directed upward, that is, toward the front side, the contact member may be formed on an inner surface as wide as an area corresponding to the loop touch screen. When the connection member is directed downward, that is, toward the rear side, the contact member may be formed on the inner surface with respect to an opposite area to the area including the loop touch screen.

Exemplary embodiments have been described such that the main display of the main body module and the loop touch screen of the rotation-type each have a separate screen. However, aspects are not limited thereto such that the rotation-type touch screen module may be formed to have no bezel or a narrow bezel so that the loop touch screen may be used as a display extending from the main display. That is, a display extension effect may be achieved. In this case, the control unit may divide an image in consideration of surface areas and ratio of the main display of the loop touch screen, and accordingly output images respectively to the main display and the loop touch screen.

Because a loop touch screen of a rotation-type touch screen module connected to a main body module is rotatable in a physical, hardware manner rather than a software manner, a more interactive interface may be provided and operational accuracy may be increased.

In addition, a loop touch screen may rotate without interfering with other components while maintaining a reliable electrical connection with a control unit.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A touch screen module connectable to a terminal, the touch screen module comprising:
at least one roller disposed in the touch screen module; and
a touch screen disposed about the at least one roller.

2. The touch screen module of claim 1, wherein the touch screen is rotatable about the at least one roller.

3. The touch screen module of claim 2, wherein the touch screen is rotatable throughout 360°.

4. The touch screen module of claim 1, wherein the touch screen comprises at least one of a recess or a protrusion disposed on a surface of the touch screen disposed adjacent to the at least one roller;
wherein the at least one roller comprises at least one of the other of a recess or a protrusion disposed on a surface of the at least one roller disposed adjacent to the touch screen, and
wherein the at least one recess and the at least one protrusion align to synchronize rotation of the touch screen and the at least one roller.

5. The touch screen module of claim 4, further comprising:
a driver integrated circuit (IC) to drive the touch screen,
wherein the driver IC is disposed as at least one of the protrusions disposed on and extending from the surface of the touch screen disposed adjacent to the at least one roller.

6. The touch screen module of claim 1, further comprising:
a support structure disposed adjacent to the at least one roller; and
a detection unit disposed in the support structure to detect at least one of a rotation of the at least one roller and the touch screen.

7. The touch screen module of claim 6, wherein the detection unit detects rotation of the at least one roller according to at least one of magnets disposed in the at least one roller and at least one recess disposed in a surface of the at least one roller.

8. The touch screen module of claim 6, wherein the detection unit detects a rotation of the touch screen according to at least one protrusion disposed on a surface of the touch screen.

9. The touch screen module of claim 1, wherein the touch screen comprises a flexible printed circuit board (FPCB).

10. The touch screen module of claim 1, further comprising:
a support structure disposed adjacent to the at least one roller, the touch screen being rotatable about the at least one roller and the support structure; and
contact members disposed on a surface of the touch screen disposed adjacent to the support structure.

11. The touch screen module of claim 10, further comprising:
connection members disposed in the support structure to contact the contact members.

12. The touch screen module of claim 11, wherein the connection members comprise:
a contact portion disposed to contact the contact members;
a fixed portion fixed to the support structure; and
an elastic portion to extend between the contact portion and the fixed portion to bias the contact portion toward the contact members.

13. The touch screen module of claim 1, wherein the touch screen comprises:
a support structure disposed adjacent to the at least one roller, the touch screen being rotatable about the at least one roller and the support structure;
an input unit to receive touches; and
a display disposed between the input unit and at least one of the at least one roller and the support structure.

14. The touch screen module of claim 13, further comprising:
a first contact member disposed on an inner surface of the display;
a second contact member disposed on an inner surface of the input unit; and
connection members disposed in the support structure to contact the first contact member and the second contact member, respectively.

15. A terminal, comprising:
a main body module comprising a control unit; and
a rotation-type touch screen module disposed at one side of the main body module, the rotation-type touch screen module comprising:
a module housing extending from the main body module, and
a loop touch screen rotatable about at least a portion of the module housing in at least one direction, the loop touch screen comprising at least one contact member electrically connected to the control unit and disposed on an inner surface of the loop touch screen.

16. The terminal of claim 15, wherein the rotation-type touch screen module further comprises:
at least one roller disposed in the module housing;
a support structure disposed adjacent to the at least one roller in the module housing; and
at least one connection member disposed in the support structure to contact the at least one contact member.

17. The terminal of claim 16, wherein the at least one roller comprises at least one of a recess or a protrusion disposed on a surface of the at least one roller, and the loop touch screen comprises at least one of the other of a recess or a protrusion disposed on a surface of the loop touch screen, and
wherein the at least one recess and the at least one protrusion align to synchronize a rotation of the loop touch screen and the at least one roller.

18. The terminal of claim 17, wherein the at least one protrusion comprises:
a driver integrated circuit (IC) disposed on the surface of the loop touch screen disposed to align with the at least one recess.

19. The terminal of claim 16, further comprising:
at least one detection unit disposed in the support structure to detect a rotation of at least one of the at least one roller and the loop touch screen.

20. A terminal, comprising:
at least one roller disposed in the terminal; and
a touch screen disposed rotatably about the at least one roller to rotate in synchronization with the at least one roller.
